(19) United States
(12) Patent Application Publication
(10) Pub. No.: US 2004/0226415 A1
(43) Pub. Date: Nov. 18, 2004

(54) Apparatus for firmly connecting wrench with socket

(76) Inventor: Terence Chen, Lo Tung Town (TW)

Correspondence Address: BIRCH STEWART KOLASCH & BIRCH, PO BOX 747, FALLS CHURCH, VA, 22040-0747, US

(21) Appl. No.: 10/454,245

(22) Filed: Jun. 5, 2003

(30) Foreign Application Priority Data
May 14, 2003 (TW) 92113014

(51) Int. Cl. B25B 13/46

(52) U.S. Cl. 81/63.1

(57) ABSTRACT

An apparatus is provided for connecting an annular gear of a wrench with a socket. The apparatus includes a joint and a C-ring. The joint includes a first insert for insertion in the annular gear, a second insert extending from the first insert for insertion in the socket and a neck formed at the first insert. The C-ring includes a middle section, two lateral sections extending from the middle section and two ends each extending from one of the lateral sections. Before the first insert is inserted in the annular gear, the middle section and the ends contact the neck while the lateral sections extend from the neck.

### FIELD OF INVENTION

The present invention relates to an apparatus for firmly connecting a wrench with a socket.

### BACKGROUND OF INVENTION

Taiwanese Patent Publication No. 366840 discloses two C-rings 3 and 4 for holding a socket 2 to a wrench 1. The wrench 1 includes a handle 11, an annular head 12 formed at an end of the handle 11 and an annular gear 121 put rotationally in the annular head 12. A mechanism is arranged between the annular head 12 and the annular gear 121 so that the annular head 12 can selectively drive the annular gear 121 in one of two opposite directions. The annular gear 121 can be engaged with the socket 2. Referring to FIG. 2, the annular gear 121 includes an annular groove 1211 defined in an internal face thereof. A C-ring 3 is put in the annular groove 1211. The C-ring 3 includes three bosses 31 formed on an internal face (see FIG. 2) or an external face (see FIG. 5) thereof. These bosses 31 are used for firmly holding the socket 2. It is however difficult to define the annular groove 1211 in the annular gear 121 and form the bosses 31 on the C-ring 3. Referring to FIG. 7, instead of including the annular groove 1211 in the annular gear 121, the socket 2 includes an annular groove 212 defined therein. A C-ring 4 is put in the annular groove 212 for pressing against the internal face of the annular gear 121. This is an expansive practice since an annular groove must be defined in each of the sockets of a toolkit. The present invention is therefore intended to obviate or at least alleviate the problems encountered in prior art.

### SUMMARY OF INVENTION

It is the primary objective of the present invention to provide an effective and cheap joint for connecting a wrench with a socket.

According to the present invention, an apparatus is provided for connecting an annular gear of a wrench with a socket. The apparatus includes a joint and a C-ring. The joint includes a first insert for insertion in the annular gear, a second insert extending from the first insert for insertion in the socket and a neck formed at the first insert. The C-ring includes a middle section, two lateral sections extending from the middle section and two ends each extending from one of the lateral sections. Before the first insert is inserted in the annular gear, the middle section and the ends contact the neck while the lateral sections extend from the neck.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a joint for connecting a wrench with a socket for driving a fastener according to the preferred embodiment of the present invention.

FIG. 2 is an exploded view of the joint of FIG. 1.

FIG. 3 is a top view of a C-ring used in the joint of FIG. 2.

FIG. 4 is a cross-sectional view of the joint of FIG. 1.

FIG. 5 is a cross-sectional view of the joint of FIG. 1 inserted in a ring of a wrench.

### DETAILED DESCRIPTION OF PREFERRED EMBODIMENT

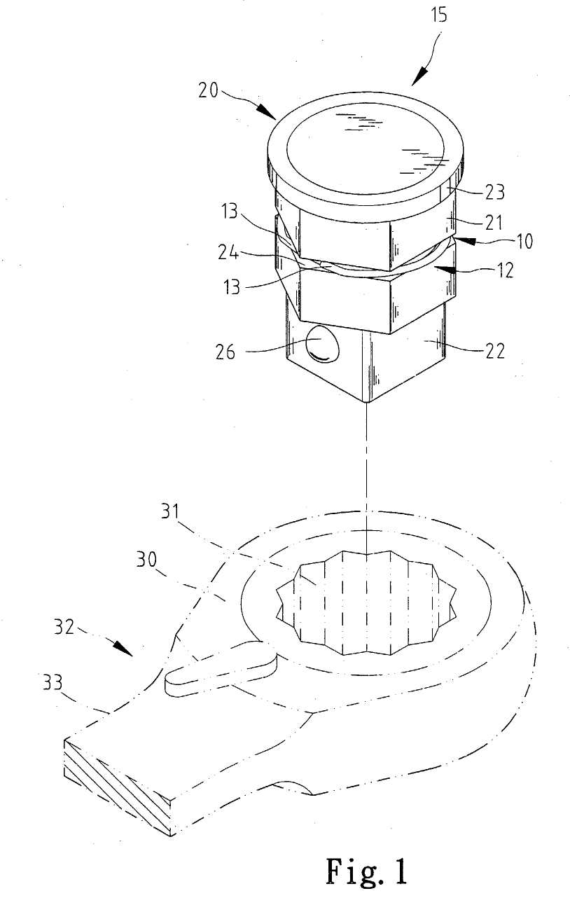

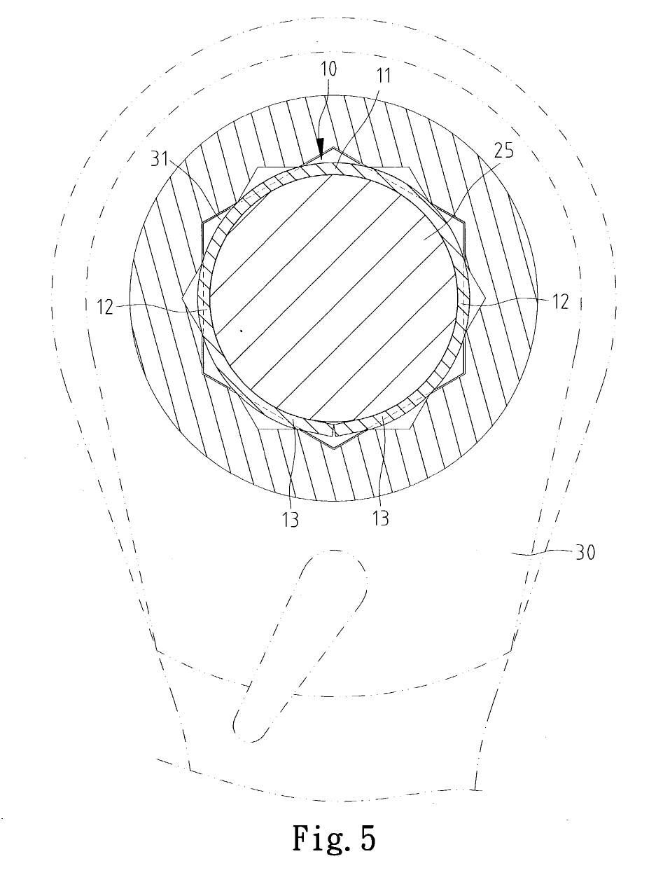

Referring to FIGS. 1 and 5, according to the preferred embodiment of the present invention, an apparatus 15 is provided for firmly connecting a wrench 32 with a socket (not shown).

The wrench 32 includes a handle 33, an annular head 30 formed at an end of the handle 33 and an annular gear 31 put rotationally in the annular head 30. Although not shown, a mechanism is arranged between the annular head 30 and the annular gear 31 so that the annular head 30 can selectively drive the annular gear 31 in one of two opposite directions.

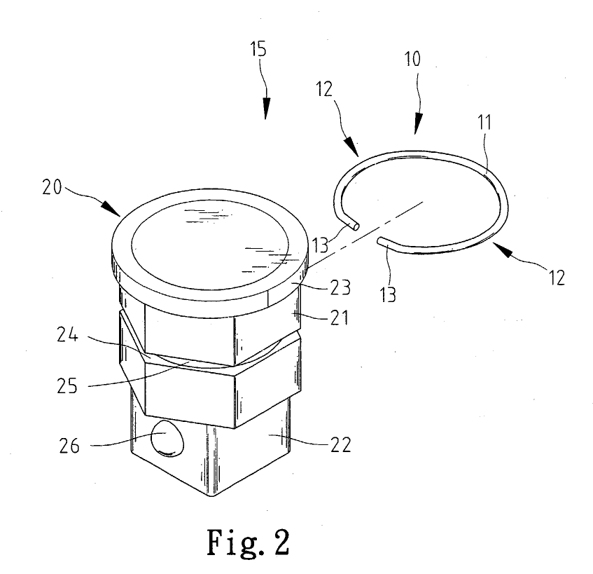

Referring to FIG. 2, the apparatus 15 includes a joint 20 for engagement with the socket and a C-ring 10 for firmly engaging the joint 20 with the annular gear 31.

The joint 20 includes a stop 23, a first insert 21 extending from the stop 23 and a second insert 22 extending from the first insert 22. The stop 23 is in the form of a disc. The stop 23 can rest on the annular gear 31 so as to avoid the joint 20 escaping the annular gear 31. The first insert 21 can be inserted in the annular gear 31. An annular groove 24 is defined in the first insert 21 so as to receive the C-ring 10. The annular groove 24 extends about a neck 25. The second insert 22 can be inserted in the socket. A ball detent 26 is installed at the second insert 22 so as to hold the socket to the second insert 22.

Referring to FIG. 3, the C-ring 10 includes a middle section 11, two lateral sections 12 projecting from the middle section 11 in opposite directions and two ends 13 each projecting from one of the lateral sections 12. A circle (not numbered) is shown in phantom lines. The middle section 11 and the ends 13 lie in the circle; however, the lateral sections 12 extend outwards from the circle.

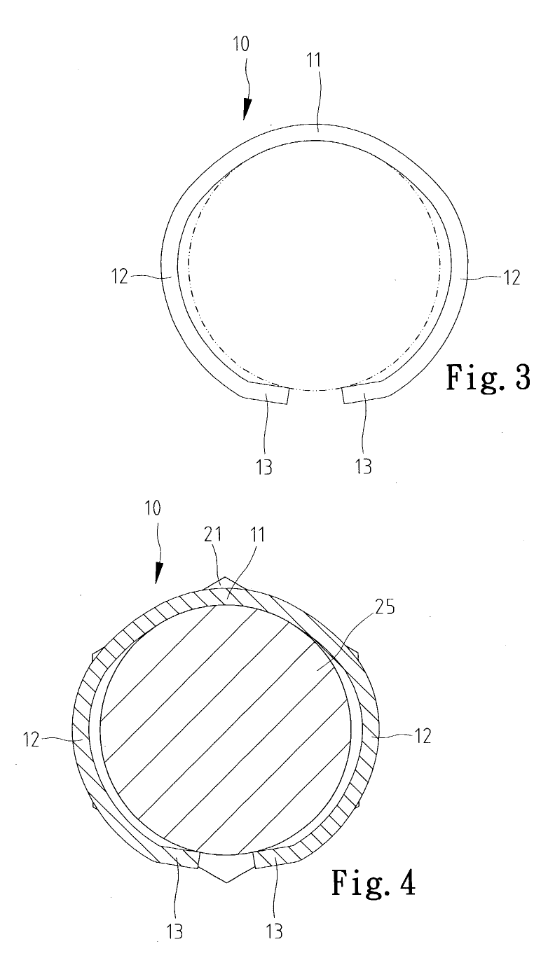

Referring to FIG. 4, the C-ring 10 is put in the annular groove 24 so that the middle section 11 and the ends 13 contact the neck 25. The lateral sections 12 extend from the neck 25.

Referring to FIG. 5, the first insert 21, as well as the C-clip 10, is inserted in the annular gear 31. Forced by means of the annular gear 31, the middle section 11, the lateral sections 12 and the ends 13 all contact the neck 25. On the other hand, because of elasticity, the C-ring 10 tends to expand so as to firmly press on the annular gear 31 at a plurality of points. Thus, the joint 20 is held firmly to the annular gear 31 by means of the C-ring 10.

In the foregoing description, the apparatus 15 is used with the wrench 32, and the first insert 21 is for insertion in the annular gear 31. However, the apparatus 15 may be used with a wrench with a box end, and the first insert 21 may be for insertion in the box end.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An apparatus for connecting an annular gear of a wrench with a socket, the apparatus including:
a joint including a first insert for insertion in the annular gear, a second insert extending from the first insert for insertion in the socket and a neck formed at the first insert; and
a C-ring including a middle section, two lateral sections extending from the middle section and two ends each extending from one of the lateral sections, the middle section and the ends contact the neck while the lateral sections extend from the neck before the first insert is inserted in the annular gear.

2. The apparatus according to claim 1 wherein the joint includes a ball detent installed at the second insert so as to hold the socket to the second insert.

3. The apparatus according to claim 1 wherein the joint includes a stop from which the stop extends, and the stop can rest on the annular gear so as to avoid the joint escaping the annular gear.

4. The apparatus according to claim 3 wherein the stop is in the form a disc.
